(19) United States
(12) Patent Application Publication
(10) Pub. No.: US 2024/0296101 A1
(43) Pub. Date: Sep. 5, 2024

(54) SERVER FAULT LOCATING METHOD AND APPARATUS, ELECTRONIC DEVICE, AND STORAGE MEDIUM

(71) Applicant: INSPUR SUZHOU INTELLIGENT TECHNOLOGY CO., LTD.

(72) Inventor: Xuejun TENG, Suzhou (CN)

(73) Assignee: INSPUR SUZHOU INTELLIGENT TECHNOLOGY CO., LTD., Suzhou, Jiangsu (CN)

(21) Appl. No.: 18/278,962

(22) PCT Filed: Jan. 28, 2022
(86) PCT No.: PCT/CN2022/074594

§ 371 Date: Aug. 25, 2023

(30) Foreign Application Priority Data
Sep. 28, 2021 (CN) 202111139366.3

(51) Int. Cl. G06F 11/22; G06F 11/34; H04L 41/12

(52) U.S. Cl. CPC G06F 11/2273; G06F 11/3419; G06F 11/3452; H04L 41/12

(57) ABSTRACT

The present application discloses a server fault locating method and apparatus, an electronic device, and a storage medium. The method includes: acquiring topology architecture information of a server, wherein the topology architecture information includes connection relationships between a plurality of modules to be detected and attribute information corresponding to the modules to be detected; based on the topology architecture information, determining a theoretical value of each target performance parameter in each of the modules to be detected; acquiring an actual value of the target performance parameter during operation of each of the modules to be detected; and comparing and analyzing the actual value with the theoretical value, and determining a faulty module among the a plurality of modules to be detected according to a comparison and analysis result.

### CROSS-REFERENCE TO RELATED APPLICATION

The present application claims the priority of Chinese Patent Application No. 202111139366.3 entitled “SERVER FAULT LOCATING METHOD AND APPARATUS, ELECTRONIC DEVICE, AND STORAGE MEDIUM” filed with Chinese Patent Office on Sep. 28, 2021, the entire contents of which are incorporated by reference in the present application.

### TECHNICAL FIELD

The present application relates to the technical field of servers, and in particular to a server fault locating method and apparatus, an electronic device, and a storage medium.

### BACKGROUND

Users' demand for storage applications can be directly reflected in the requirements on storage performance indicators. Performance is an important issue in the field of servers and is also a crucial indicator for evaluating a server system. It is an important direction for research in the field of server performance evaluation to make performance indicators designed for a server such as bandwidth, IOPS, read and write be consistent with actual test result data, and evaluate a bottleneck of difference from an actual performance test in time and provide an effective evaluation for rectification if the performance indicators are inconsistent with test results. A current performance testing method is to implant a tracking program in a storage system, directly acquire data on performance indicators, and analyze the performance of the storage system by means of operating data acquired. When there is a problem in a service environment of the performance, resulting in inconsistency between planned data and test results, a bottleneck of difference from an actual performance test cannot be evaluated in time, a specific fault point cannot be located, and thus an effective evaluation for rectification cannot be provided. Therefore, how to provide a solution to the above technical problems is a problem that those skilled in the art need to solve at present.

### SUMMARY

In view of this, the present application provides a server fault locating method, which aims to solve the technical problem that when there is a problem in server performance, resulting in consistency between a planned value and a test result, the location of a fault cannot be evaluated in time.

According to a first aspect, the embodiments of the present application provide a server fault locating method, including:
acquiring topology architecture information of a server, wherein the topology architecture information includes connection relationships between a plurality of modules to be detected and attribute information corresponding to the modules to be detected;
based on the topology architecture information, determining a theoretical value of each target performance parameter in each of the modules to be detected;
acquiring an actual value of the target performance parameter during operation of each of the modules to be detected; and
comparing and analyzing the actual value with the theoretical value, and determining a faulty module among the plurality of modules to be detected according to a comparison and analysis result.

In an embodiment of the present application, the step of determining a theoretical value of each target performance parameter in each of the modules to be detected based on the topology architecture information includes:
acquiring a bandwidth parameter of each of the modules to be detected in current fault locating, so as to determine a data block corresponding to the bandwidth parameter;
based on the attribute information corresponding to the modules to be detected, determining a rate and a bandwidth of a node between adjacent modules to be detected; and
based on the data block and the rate and bandwidth, determining a bandwidth theoretical value corresponding to each of the modules to be detected.

In an embodiment of the present application, the target performance parameter includes IOPS, and the step of determining a theoretical value of each target performance parameter in each of the modules to be detected based on the topology architecture information includes:
acquiring a maximum number of batch instructions and a running time of batch instructions sent by the modules to be detected; and
based on the maximum number of batch instructions and the running time of the batch instructions, determining a theoretical value of IOPS corresponding to each of the modules to be detected.

In an embodiment of the present application, the target performance parameter includes an instruction running time of each of the modules to be tested, and the step of comparing and analyzing the actual value with the theoretical value, and determining a faulty module among the plurality of modules to be detected according to a comparison and analysis result includes:
based on a relationship of size between a bandwidth theoretical value and a bandwidth actual value of each of the modules to be detected, determining a first target module where the actual value exceeds the theoretical value among the modules to be detected;
based on a relationship of size between a theoretical value of the instruction running time and an actual value of the instruction running time of each of the modules to be detected, determining a second target module where the actual value exceeds the theoretical value among the modules to be detected; and
determining the faulty module based on the first target module and the second target module.

In an embodiment of the present application, the method further includes:
determining a fault category based on attribute information of the faulty module; and
tuning the faulty module according to the fault category.

In an embodiment of the present application, the step of determining a fault category based on attribute information of the faulty module includes:
identifying a test category of the faulty module, a category of performance calculation, and a category of the faulty module, so as to determine the fault category.

In an embodiment of the present application, the step of tuning the faulty module according to the fault category includes:
based on the determined fault category, determining a fault point of the faulty module and adjusting the fault point.

According to a second aspect, the embodiments of the present application provide a server fault locating apparatus, including:
an acquisition architecture unit configured to acquire topology architecture information of a server, wherein the topology architecture information includes connection relationships between a plurality of modules to be detected and attribute information corresponding to the modules to be detected;
a performance calculation unit configured to determine a theoretical value of each target performance parameter in each of the modules to be detected based on the topology architecture information;
a performance acquisition unit configured to acquire an actual value of the target performance parameter during operation of each of the modules to be detected; and
a fault locating unit configured to compare and analyze the actual value with the theoretical value, and determining a faulty module among the plurality of modules to be detected according to a comparison and analysis result.

In an embodiment of the present application, the step of determining a theoretical value of each target performance parameter in each of the modules to be detected based on the topology architecture information includes:
acquiring a bandwidth parameter of each of the modules to be detected in current fault locating, so as to determine a data block corresponding to the bandwidth parameter;
based on the attribute information corresponding to the modules to be detected, determining a rate and a bandwidth of a node between adjacent modules to be detected; and
based on the data block and the rate and bandwidth, determining a bandwidth theoretical value corresponding to each of the modules to be detected.

In an embodiment of the present application, the target performance parameter includes IOPS, and the step of determining a theoretical value of each target performance parameter in each of the modules to be detected based on the topology architecture information includes:
acquiring a maximum number of batch instructions and a running time of batch instructions sent by the modules to be detected; and
based on the maximum number of batch instructions and the running time of the batch instructions, determining a theoretical value of IOPS corresponding to each of the modules to be detected.

According to a third aspect, the embodiments of the present application provide an electronic device, including: a memory configured to store computer instructions; and a processor configured to execute the computer instructions to implement the server fault locating method described above, wherein the memory and the processor are communicably connected with each other.

According to a fourth aspect, the embodiments of the present application provide a computer-readable storage medium configured to store computer instructions, wherein the computer instructions are configured to enable a computer to execute the server fault locating method described above.

The server fault locating method provided in the present application includes acquiring topology architecture information of a server, wherein the topology architecture information includes connection relationships between a plurality of modules to be detected and attribute information corresponding to the modules to be detected; based on the topology architecture information, determining a theoretical value of each target performance parameter in each of the modules to be detected; acquiring an actual value of the target performance parameter during operation of each of the modules to be detected; and comparing and analyzing the actual value with the theoretical value, and determining a faulty module among the a plurality of modules to be detected according to a comparison and analysis result.

It can be seen that in the server fault locating method provided in the present application, by acquiring topology architecture information in a server and a theoretical value and an actual value of a target performance parameter in each module to be detected, and comparing and analyzing the theoretical value with the actual value, a faulty module can be directly located according to a comparison and analysis result. Compared with the prior art, the method achieves accurate locating of a faulty module to be detected of a server, and improves the efficiency of server fault diagnosis.

The server fault locating apparatus, electronic device and computer-readable storage medium provided in the present application all have the above beneficial effects, which will not be repeated here.

### BRIEF DESCRIPTION OF THE DRAWINGS

In order to illustrate the prior art and the technical solutions in the embodiments of the present application more clearly, the drawings that need to be used in the description of the prior art and the embodiments of the present application will be briefly described below. Of course, only some of the embodiments of the application are described in the following drawings related to the embodiments of the present application, and those of ordinary skill in the art can obtain other drawings according to the drawings provided, and the other drawings obtained also fall into the scope of protection of the present application.

FIG. 1 is a schematic flowchart of a server fault locating method provided in an embodiment of the present application;

FIG. 2 is a schematic structural diagram of a server fault locating apparatus provided in an embodiment of the present application;

FIG. 3 is a schematic structural diagram of an electronic device provided in an embodiment of the present application; and

FIG. 4 is a schematic structural diagram of a storage medium provided in an embodiment of the present application.

### DETAILED DESCRIPTION

It should be understood that the specific embodiments described herein are only used to explain the present application, and are not intended to limit the present application.

The technical solutions in the embodiments of the present application will be described clearly and completely below with reference to the drawings in the embodiments of the present application. Obviously, the embodiments described are only some of rather than all of the embodiments of the present application. Based on the embodiments in the present application, all other embodiments obtained by those of ordinary skill in the art without creative work belong to the scope of protection of the present application.

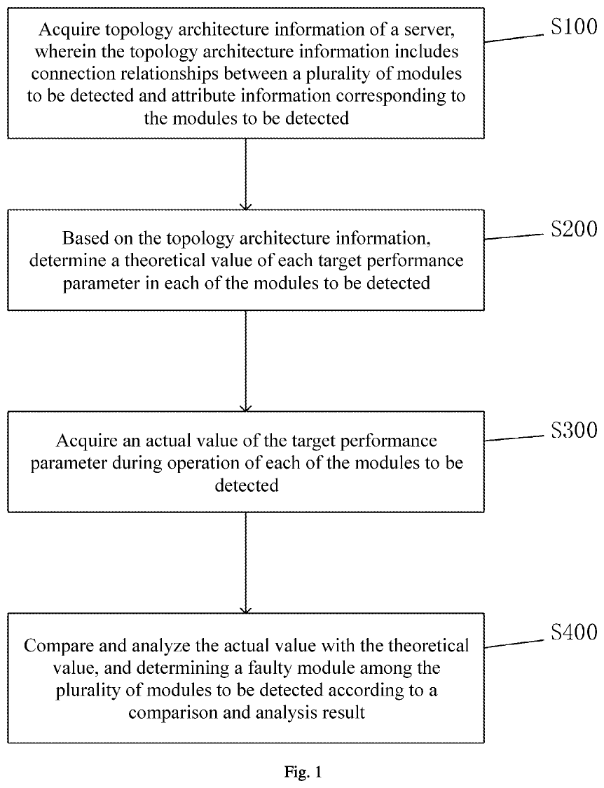

As shown in FIG. 1, the embodiments of the present application provide a server fault locating method, including the following steps:

S100, acquiring topology architecture information of a server, wherein the topology architecture information includes connection relationships between a plurality of modules to be detected and attribute information corresponding to the modules to be detected.

In this embodiment, there are two main parameters that reflect the performance of a storage system of the server, including bandwidth and IOPS. Bandwidth is used to measure the IO capability of the storage system to process sequential reads and writes of large data blocks, wherein the unit is MB/S. The higher the bandwidth, the better the performance. IOPS (the number of IO reads and writes per second of a disk device) is used to measure the IO capability of the storage system to process random reads and writes of small data blocks, that is, the number of operations for IO reads and writes per second. The higher the IOPS, the greater the capability of the storage system to process IO.

This step aims to obtain topology architecture information of the server. The topology architecture information includes connection relationships between a plurality of modules to be detected and attribute information corresponding to the modules to be detected. In this embodiment, the modules to be detected include a motherboard module, a controller module, a backplane module, and a hard disk module. The motherboard module, the controller module, the backplane module, and the hard disk module are electrically connected in sequence. Attribute information of the motherboard module includes various types, such as a PCH type, a PCIE type, etc. Thus, the attribute information of each of the modules to be detected needs to be acquired first, and operation detection is carried out for different attribute information, which improves the accuracy of detection.

In some other embodiments, the topology architecture information of the server generally includes the following three situations: (1) the modules to be detected include a motherboard module, a backplane module, and a hard disk module, and the motherboard module, the backplane module, and the hard disk module are electrically connected in sequence, wherein the motherboard module is of a PCH type; (2) the modules to be detected include a motherboard module, a controller module, a backplane module, and a hard disk module, and the motherboard module, the controller module, the backplane module, and the hard disk module are electrically connected in sequence, wherein the motherboard module is of a PCIE type and the controller module is SAS; and (3) the modules to be detected include a motherboard module, a controller module, a backplane module, and a hard disk module, and the motherboard module, the controller module, the backplane module, and the hard disk module are electrically connected in sequence, wherein the motherboard module is of a PCIE type, the controller module is SAS, and the backplane module is Expander. The subsequent embodiments will be described in detail taking as an example the topology architecture information of the server in (3).

S200, based on the topology architecture information, determining a theoretical value of each target performance parameter in each of the modules to be detected.

In this embodiment, the target performance parameters mainly include two performance parameters, bandwidth and IOPS. Theoretical values of bandwidth and IOPS are acquired by different calculation methods. The calculation of bandwidth in the performance parameters is implemented in such a manner that based on different attribute information of each module to be detected, a theoretical value of the module to be detected is directly acquired by calculation according to the attribute information. The calculation of IOPS in the performance parameters is implemented in such a manner that based on different attribute information of each module to be detected, a maximum number of theoretical batch instructions sent and a running time of the theoretical batch instructions during normal operation of the module to be detected are acquired, and then according to the maximum number of theoretical batch instructions and the running time of the theoretical batch instructions, a number of IO executed by the IO system theoretically per second is calculated, and is used as a theoretical value of IOPS. At the same time, the acquisition of the two performance parameters bandwidth and IOPS can be compared and analyzed in many aspects, which improves the comprehensiveness and accuracy of detection.

S300, acquiring an actual value of the target performance parameter during operation of each of the modules to be detected.

In this embodiment, during the operation of each module to be detected, each target performance parameter is directly detected and an actual value of the target performance parameter is acquired. The acquisition of an actual value of IOPS in the target performance parameters is mainly implemented in such a manner that during the operation of each module to be detected, a maximum number of actual batch instructions and a running time of the actual batch instructions are directly detected, and then an actual number of times of IO executed per second of the IO system is calculated according to the maximum number of actual batch instructions and the running time of the actual batch instructions, and is used as the actual value of IOPS. The acquisition of an actual value of bandwidth in the target performance parameters is mainly implemented in such a manner that during the operation of each module to be detected, if the number of batch instructions sent is fixed, the running time of the batch instructions detected is used as the actual value of bandwidth. If the number of batch instructions sent is fixed, the smaller the running time of the batch instructions, the better the performance of bandwidth. Conversely, if the number of batch instructions sent is fixed, the greater the running time of the batch instructions, the poorer the performance of bandwidth. The actual value of each target performance parameter of each module to be detected during operation can be directly acquired, which is convenient for comparing the actual value with the theoretical value of the target performance parameter.

S400, comparing and analyzing the actual value with the theoretical value, and determining a faulty module among the plurality of modules to be detected according to a comparison and analysis result.

In this embodiment, the theoretical value of each module to be detected is compared with the actual value, and a faulty module can be accurately located according to a comparison result of each module to be detected. For example, while detecting the motherboard module, attribute information of the motherboard module is first acquired, and then theoretical values of bandwidth and IOPS in the target performance parameters of the motherboard module are calculated. During the operation of the motherboard module, actual values of bandwidth and IOPS in the target performance parameters of the motherboard module are acquired, and then the theoretical value and the actual value of bandwidth of the motherboard module, as well as the theoretical value and the actual value of IPOS are compared and analyzed. If the theoretical value and the actual value differ greatly, the faulty module can be accurately located, and at the same time, analysis and comparison are performed on bandwidth and IOPS in the target performance parameters of each module to be detected, which improves the accuracy of the faulty module and enables comprehensive detection of the target performance parameters.

In this embodiment, by acquiring topology architecture information in a server and a theoretical value and an actual value of a target performance parameter of each module to be detected, and comparing and analyzing the theoretical value with the actual value, a faulty module can be directly located according to a comparison and analysis result. Compared with the prior art, the method achieves accurate locating of a fault of a module to be detected of the server, and improves the efficiency of server fault diagnosis.

In an optional embodiment of the present application, the step of determining a theoretical value of each target performance parameter in each of the modules to be detected based on the topology architecture information as described above may include:
(1) acquiring a bandwidth parameter of each of the modules to be detected in current fault locating, so as to determine a data block corresponding to the bandwidth parameter.

In this embodiment, the bandwidth parameters include sequential read, sequential write, random write, and random read. For example, when the bandwidth parameters are sequential read and sequential write, the data block selected is 128 KB; when the bandwidth parameters are random read and random write, the data block selected is 4 KB. After fault locating of a faulty module, the bandwidth parameters of the faulty module are determined, and a corresponding data block is selected according to different bandwidth parameters.
(2) based on the attribute information corresponding to the modules to be detected, determining a rate and a bandwidth of a node between adjacent modules to be detected.

In this embodiment, to determine a rate and a bandwidth of a node between adjacent modules to be detected, it needs to determine adjacent modules to be detected based on the connection relationships between the modules to be detected in the topology architecture information. For example, first a node between the motherboard module and the controller module is selected, and a rate and a bandwidth of the node link are calculated. For example, in the case the attribute information of the motherboard module is PCIE, the PCIE of the motherboard module is downlink, PCIE3.0, X8 is selected, and a theoretical bandwidth of 6400 MB/s can be automatically calculated. Then a node between the controller module and the backplane module is selected, and a rate and a bandwidth of the node link are calculated. For example, in the case the controller module is a Serial Attached SCSI hard disk (abbreviated as SAS), by selecting, in the node, downlink, Serial Attached SCSI hard disk (abbreviated as SAS) 3.0, and bandwidth X8, a theoretical bandwidth of 8320 MB/S can be automatically calculated. Afterwards, the number of hard disk modules and a corresponding target performance parameter in SPEC are inputted, and downlink is filled in a node between the backplane module and the hard disk module. For example, the number of hard disk modules is 12, the target performance parameter is sequential write, and a theoretical bandwidth of 6480 MB/S can be automatically calculated. Finally, the attribute information of the backplane module is selected: expander, Serial ATA hard disk (abbreviated as SATA) 3.0, EDFB/Buffer enabled, uplink PHY enabled rate of 1.000, and downlink PHY enabled rate of 1.000. A bandwidth bottleneck point is a bottleneck point of a theoretical value of bandwidth obtained by summing the rate and the bandwidth of the node between adjacent modules to be detected, and the bottleneck point of the theoretical value of bandwidth can be automatically calculated by the above process.
(3) based on the data block and the rate and bandwidth, determining a bandwidth theoretical value corresponding to each of the modules to be detected.

In this embodiment, by determining a theoretical value of bandwidth corresponding to each of the modules to be detected, a bandwidth value of each module to be detected under normal operation can be acquired.

In an optional embodiment of the present application, the above target performance parameter includes IOPS, and the step of determining a theoretical value of each target performance parameter in each of the modules to be detected based on the topology architecture information may include the following steps:
(1) acquiring a maximum number of batch instructions sent by the modules to be detected and a running time of the batch instructions; and
(2) based on the maximum number of batch instructions and the running time of the batch instructions, determining a theoretical value of IOPS corresponding to each of the modules to be detected.

In this embodiment, during the operation of the modules to be detected, a maximum number of batch instructions sent by the modules to be detected and a running time of the batch instructions can be directly acquired, and the maximum number of batch instructions is divided by the running time of the batch instructions to obtain a number of IO operations executed by the IO system per second (i.e., IOPS) and thereby to obtain a theoretical value of IOPS corresponding to each module to be detected.

In an optional embodiment of the present application, the above target performance parameter includes an instruction running time of each module to be detected, and the step of comparing and analyzing the actual value with the theoretical value, and determining a faulty module among the plurality of modules to be detected according to a comparison and analysis result may include the following steps:
(1) based on a relationship of size between a bandwidth theoretical value and a bandwidth actual value of each of the modules to be detected, determining a first target module where the actual value exceeds the theoretical value among the modules to be detected. In this embodiment, the first target module includes a bandwidth threshold module, wherein as to whether the ratio of the actual value of the bandwidth to the theoretical value of the bandwidth is within the bandwidth threshold module, a single disk test is performed if the hard disk module is a single disk to determine whether the ratio of the actual value of the bandwidth of each module to be detected to the theoretical value of the bandwidth meets the bandwidth threshold module. In this embodiment, if the ratio of the actual value of the bandwidth of the module to be detected to the theoretical value of the bandwidth reaches 90% of the bandwidth threshold module, the module to be detected is qualified, otherwise it is unqualified, and the unqualified module to be detected is a faulty module.
(2) based on a relationship of size between a theoretical value of the instruction running time and an actual value of the instruction running time of each of the modules to be detected, determining a second target module where the actual value exceeds the theoretical value among the modules to be detected.

In this embodiment, the second target module includes the instruction running time of bandwidth of each module to be detected, and it is determined whether an actual value of the instruction running time of each module to be detected is within the range of a theoretical value. If the difference between the actual value and the theoretical value of the instruction running time of a module to be detected is large, then the module to be detected is a faulty module.
(3) determining the faulty module based on the first target module and the second target module.

In this embodiment, based on the respective judgment and analysis of the first target module and the second target module, the faulty module can be located according to an analysis result.

In an optional embodiment of the present application, the method further includes the following steps:
(1) determining a fault category based on attribute information of the faulty module; and
(2) tuning the faulty module according to the fault category.

In this embodiment, a fault category is determined based on attribute information of the faulty module. The attribute information of the faulty module is determined, the fault category is determined according to different attribute information, and then different tuning methods are configured according to the fault category, which enables a reasonable and effective plan for each module to be detected while solving the current user's requirement for each target performance parameter of each module to be detected in the server, and evaluation can be made in time and an effective solution for rectification can be provided when the theoretical value planned for the target performance parameter of each module to be detected is inconsistent with the actual value.

In an optional embodiment of the present application, the above step of determining a fault category based on attribute information of the faulty module may include the following step:
(1) identifying a test category of the faulty module, a category of performance calculation, and a category of the faulty module, so as to determine the fault category.

In this embodiment, identifying the category of the faulty module includes whether the hard disk module is a single disk or parallel; identifying the category of performance calculation includes identifying whether the target performance parameter is bandwidth of a large data block or IOPS of a small data block; identifying the category of the faulty module includes identifying types of hard disk modules, wherein the types of hard disk modules include Serial ATA hard disk (abbreviated as SATA), Serial Attached SCSI hard disk (abbreviated as SAS), Hard-Disk Drive (abbreviated as HDD), and Solid State Disk or Solid State Drive (abbreviated as SSD), etc.

In an optional embodiment of the present application, the above step of tuning the faulty module according to the fault category may include the following step:
(1) detecting a setting mode of the server based on the determined fault category.

In this embodiment, based on the determined fault category, a setting mode of the server is detected, and thereby tuning is performed. First, settings of a central processing unit (abbreviated as CPU) and a basic input output system (abbreviated as BIOS) are detected to determine whether the basic input output system has closed all standby modes and is enabled to be in a performance running mode; an CPU binding operation is checked and enabled, and after reasonable settings, the above target performance parameter will be improved by 5%; in the next step, the backplane module is checked, taking as an example that the backplane module attribute information is Expander: if the rear end of the expander is a serial ATA (abbreviated as SATA) hard disk, the chip is determined, and if the chip is Broadcom (a brand from Broadcom Corporation), a bridge tool needs to be adjusted to an enabled state, and if the chip is microchip (a brand from Microchip Technology Inc.), a buffer needs to be adjusted to an enabled state. The next step is to check the hard disk module. Taking as an example that the attribute information of the hard disk module is Solid State Disk or Solid State Drive (abbreviated as SSD), the SSD needs to be formatted and erased first; if the attribute information of the hard disk module is Hard Disk Drive (abbreviated as HDD), then formatting and erasing are not required. The next step is to check that Raid policy settings are correct, wherein Raid refers to Redundant Array of Independent Disks, which combines multiple hard disks to form a whole, and cooperates with different management policies to meet different storage requirements. For different hard disk module attribute information, different Raid policies are adopted. The following is Raid policies for different hard disk modules:

Raid policies of a Serial Attached SCSI hard disk and Raid policies of a hard disk drive: Broadcom raid card, read policy=read ahead; write police=always write back; IO policy=direct; disk cache=enable; microchip raid card, read caching=enable; write caching=enable always; drive write cache=enable all;

Raid policies for SSDs:

Broadcom raid card, read policy-normal; write police=write through; IO policy=direct; disk cache=unchanged; microchip raid card, read caching=enable; write caching=enable always; drive write cache=enable all. Other detections include ensuring that all interfaces are operating at the highest supported connection rate, whether the cable connection is normal, and whether uplink settings of the backplane module are correct.

It should be understood that although the various steps in the flow chart of FIG. 1 are displayed sequentially as indicated by arrows, these steps are not necessarily executed sequentially in the order indicated by the arrows. Unless otherwise specified herein, there is no strict order restriction on the execution of these steps, and these steps can be executed in another order. Moreover, at least some of the steps in FIG. 1 may include multiple steps or stages, and these steps or stages may not necessarily be executed at the same time, but may be executed at different times, and these steps or stages may not necessarily be executed sequentially, but may be executed in turn or alternately with other steps or at least a part of steps or stages in other steps.

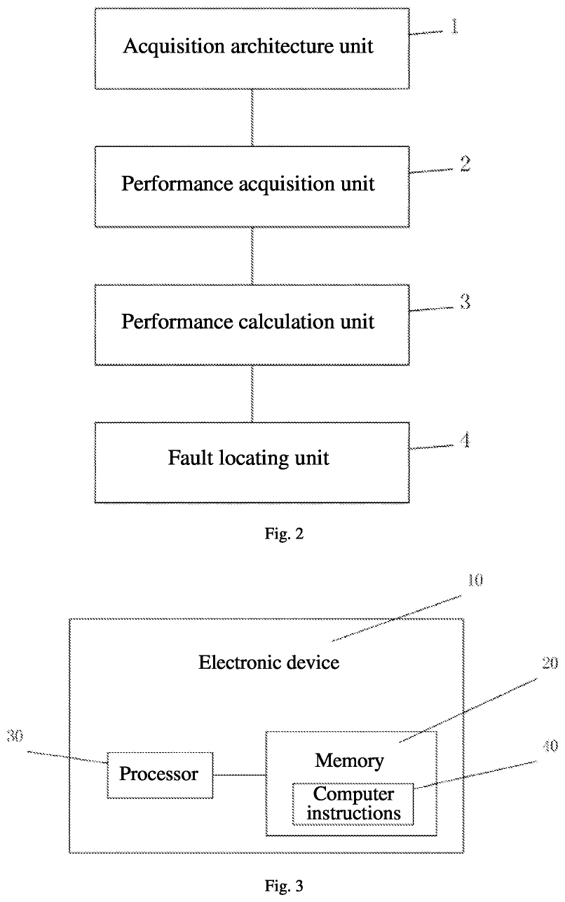

In order to solve the above technical problems, the present application also provides a server fault locating apparatus, as shown in FIG. 2, which is a schematic structural diagram of a server fault locating apparatus provided in the present application, the server fault locating apparatus including an acquisition architecture unit 1, a performance calculation unit 2, a performance acquisition unit 3, and a fault locating unit 4.

The acquisition architecture unit 1 is configured to acquire topology architecture information of a server, wherein the topology architecture information includes connection relationships between a plurality of modules to be detected and attribute information corresponding to the modules to be detected.

In this embodiment, there are two main parameters that reflect the performance of the storage system of the server, including bandwidth and IOPS. Bandwidth is used to measure the IO capability of the storage system to process sequential reads and writes of large data blocks, wherein the unit is MB/S. The higher the bandwidth, the better the performance. IOPS (the number of IO reads and writes per second of the disk device) is used to measure the IO capability of the storage system to process random reads and writes of small data blocks, that is, the number of IO reads and writes per second. The higher the IOPS, the greater the capability of the storage system to process IO.

This step aims to obtain topology architecture information of the server. The topology architecture information includes connection relationships between a plurality of modules to be detected and attribute information corresponding to the modules to be detected. The modules to be detected include a motherboard module, a controller module, a backplane module, and a hard disk module. The motherboard module, the controller module, the backplane module, and the hard disk module are electrically connected in sequence. Attribute information of the motherboard module includes various types, such as a PCH type, a PCIE type, etc. Thus, the attribute information of each module to be detected needs to be acquired first, and operation detection is carried out for different attribute information, which improves the accuracy of detection.

The performance calculation unit 2 is configured to determine a theoretical value of each target performance parameter in each of the modules to be detected based on the topology architecture information.

In this embodiment, the target performance parameters mainly include two performance parameters, bandwidth and IOPS. Theoretical values of bandwidth and IOPS are acquired by different calculation methods. The calculation of bandwidth in the performance parameters is implemented in such a manner that based on different attribute information of each module to be detected, a theoretical value of the module to be detected is directly acquired by calculation according to the attribute information. The calculation of IOPS in the performance parameters is implemented in such a manner that based on different attribute information of each module to be detected, a maximum number of theoretical batch instructions sent and a running time of the theoretical batch instructions during normal operation of the module to be detected are acquired, and then according to the maximum number of theoretical batch instructions and the running time of the theoretical batch instructions, a number of IO executed by the IO system theoretically per second is calculated, and is used as a theoretical value of IOPS. At the same time, the acquisition of the two performance parameters bandwidth and IOPS can be compared and analyzed in many aspects, which improves the comprehensiveness and accuracy of detection.

The performance acquisition unit 3 is configured to acquire an actual value of the target performance parameter during operation of each of the modules to be detected.

In this embodiment, during the operation of each module to be detected, the target performance parameter is directly detected and an actual value of the target performance parameter is acquired. The acquisition of the actual value of IOPS in the target performance parameters is mainly implemented in such a manner that during the operation of each module to be detected, a maximum number of actual batch instructions and the running time of the actual batch instructions are directly detected, and then an actual number of times of IO executed per second of the IO system is calculated according to the maximum number of actual batch instructions and the running time of the actual batch instructions, and is used as the actual value of IOPS. The acquisition of the actual value of bandwidth in the target performance parameters is mainly implemented in such a manner that during the operation of each module to be detected, if the number of batch instructions sent is fixed, the running time of the batch instructions detected is the actual value of the bandwidth. If the number of batch instructions sent is fixed, the smaller the running time of the batch instructions, the better the performance of bandwidth. Conversely, if the number of batch instructions sent is fixed, the greater the running time of the batch instructions, the poorer the performance of bandwidth. The actual value of the target performance parameter of each module to be detected during operation can be directly acquired, which is convenient for comparing the actual value with the theoretical value of the target performance parameter.

The fault locating unit 4 is configured to compare and analyze the actual value with the theoretical value, and determine a faulty module among the plurality of modules to be detected according to a comparison and analysis result.

In this embodiment, the theoretical value of each module to be detected is compared with the actual value, and a faulty module can be accurately located according to a comparison result of each module to be detected. For example, while detecting the motherboard module, attribute information of the motherboard module is first acquired, and then theoretical values of bandwidth and IOPS in the target performance parameters of the motherboard module are calculated. During the operation of the motherboard module, actual values of bandwidth and IOPS in the target performance parameters of the motherboard module are acquired, and then the theoretical value and the actual value of bandwidth of the motherboard module, as well as the theoretical value and the actual value of IPOS are compared and analyzed. If the theoretical value and the actual value differ greatly, the faulty module can be accurately located, and at the same time, analysis and comparison are performed on bandwidth and IOPS in the target performance parameters of each module to be detected, which improves the accuracy of the faulty module and enables comprehensive detection of the target performance parameters.

As shown in FIG. 3, in order to solve the above technical problems, the present application further provides an electronic device 10. FIG. 3 is a schematic structural diagram of an electronic device 10 provided in the present application. The electronic device 10 includes a memory 20 and a processor 30. The memory 20 and the processor 30 are communicably connected with each other. The memory 20 is configured to store computer instructions 40, and the processor 30 is configured to execute the computer instructions 40 so as to execute the server fault locating method described in any one of the above items.

For the introduction of the electronic device provided in the present application, please refer to the foregoing method embodiments, which will not be repeated here.

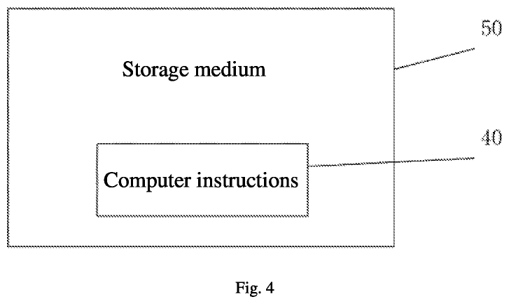

As shown in FIG. 4, in order to solve the above technical problems, the present application also provides a computer-readable storage medium 50. The computer-readable storage medium is configured to store computer instructions. The computer instructions 40 are configured to enable a computer to execute the server fault locating method described in any one of the above items.

The computer readable storage medium 50 may include: U disk, a mobile hard disk, read-only memory (ROM), random access memory (RAM), a magnetic disk, an optical disk, and other media which can store program codes.

For the introduction of the computer-readable storage medium provided in the present application, please refer to the foregoing method embodiments, which will not be repeated here.

Embodiments in the description are described in a progressive manner. Each embodiment focuses on differences from other embodiments, and the same and similar parts of each embodiment can be referred to by each other. As for the apparatus disclosed in embodiments, since it corresponds to the method disclosed in embodiments, it is described relatively simple, and for relevant details, please refer to the description of the method section.

Professionals can further realize that the units and algorithm steps of the examples described in conjunction with the embodiments disclosed herein can be implemented by electronic hardware, computer software or a combination thereof. In order to clearly illustrate the interchangeability of hardware and software, the composition and steps of each example have been generally described according to their functions. Whether these functions are executed by hardware or software depends on the specific application and design constraints of the technical solution. Professional skilled persons may use different methods to implement the described functions for each specific application, but such implementation should not be regarded as exceeding the scope of the present application.

The steps of the methods or algorithms described in conjunction with the embodiments disclosed herein may be directly implemented by hardware, software modules executed by a processor, or a combination thereof. The software module can be placed in random access memory (RAM), internal memory, read-only memory (ROM), electrically programmable ROM, electrically erasable programmable ROM, register, hard disk, removable disk, CD-ROM or any other form of storage medium known in the technical field.

The technical solutions provided in the present application have been illustrated in detail above. Specific examples are used herein to illustrate the principles and implementations of the present application, and the description of the above embodiments is only used to help understand the methods and core ideas of the present application. It should be noted that those of ordinary skill in the art can make a number of improvements and modifications to the present application without departing from the principle of the present application, and these improvements and modifications also fall within the protection scope of the present application.

1. A server fault locating method, comprising:
acquiring topology architecture information of a server, wherein the topology architecture information comprises connection relationships between a plurality of modules to be detected and attribute information corresponding to the modules to be detected;
based on the topology architecture information, determining a theoretical value of each target performance parameter in each of the modules to be detected;
acquiring an actual value of the target performance parameter during operation of each of the modules to be detected; and
comparing and analyzing the actual value with the theoretical value, and determining a faulty module among the plurality of modules to be detected according to a comparison and analysis result.

2. The server fault locating method according to claim 1, wherein the step of determining a theoretical value of each target performance parameter in each of the modules to be detected based on the topology architecture information comprises:
acquiring a bandwidth parameter of each of the modules to be detected in current fault locating, so as to determine a data block corresponding to the bandwidth parameter;
based on the attribute information corresponding to the modules to be detected, determining a rate and a bandwidth of a node between adjacent modules to be detected; and
based on the data block and the rate and bandwidth, determining a bandwidth theoretical value corresponding to each of the modules to be detected.

3. The server fault locating method according to claim 1, wherein the target performance parameter comprises IOPS, and the step of determining a theoretical value of each target performance parameter in each of the modules to be detected based on the topology architecture information comprises:
acquiring a maximum number of batch instructions and a running time of batch instructions sent by the modules to be detected; and
based on the maximum number of batch instructions and the running time of the batch instructions, determining a theoretical value of IOPS corresponding to each of the modules to be detected.

4. The server fault locating method according to claim 1, wherein the target performance parameter comprises an instruction running time of each of the modules to be tested, and the step of comparing and analyzing the actual value with the theoretical value, and determining a faulty module among the plurality of modules to be detected according to a comparison and analysis result comprises:
based on a relationship of size between a bandwidth theoretical value and a bandwidth actual value of each of the modules to be detected, determining a first target module where the actual value exceeds the theoretical value among the modules to be detected;
based on a relationship of size between a theoretical value of the instruction running time and an actual value of the instruction running time of each of the modules to be detected, determining a second target module where the actual value exceeds the theoretical value among the modules to be detected; and
determining the faulty module based on the first target module and the second target module.

5. The server fault locating method according to claim 1, wherein the method further comprises:
determining a fault category based on attribute information of the faulty module; and
tuning the faulty module according to the fault category.

6. The server fault locating method according to claim 5, wherein the step of determining a fault category based on attribute information of the faulty module comprises:
identifying a test category of the faulty module, a category of performance calculation, and a category of the faulty module, so as to determine the fault category.

7. The server fault locating method according to claim 6, wherein the step of tuning the faulty module according to the fault category comprises:
based on the determined fault category, determining a fault point of the faulty module and adjusting the fault point.

8. (canceled)

9. (canceled)

10. (canceled)

11. An electronic device, comprising:
a memory configured to store computer instructions; and
a processor configured to execute the computer instructions to implement the steps of a server fault locating method, the steps of a server fault locating method comprise:
acquiring topology architecture information of a server, wherein the topology architecture information comprises connection relationships between a plurality of modules to be detected and attribute information corresponding to the modules to be detected;
based on the topology architecture information, determining a theoretical value of each target performance parameter in each of the modules to be detected;
acquiring an actual value of the target performance parameter during operation of each of the modules to be detected; and
comparing and analyzing the actual value with the theoretical value, and determining a faulty module among the plurality of modules to be detected according to a comparison and analysis result.

12. A non-transient computer-readable storage medium, configured to store computer instructions, wherein the computer instructions are configured to enable a computer to execute the steps of a server fault locating method, the steps of a server fault locating method comprise:
acquiring topology architecture information of a server, wherein the topology architecture information comprises connection relationships between a plurality of modules to be detected and attribute information corresponding to the modules to be detected;
based on the topology architecture information, determining a theoretical value of each target performance parameter in each of the modules to be detected;
acquiring an actual value of the target performance parameter during operation of each of the modules to be detected; and
comparing and analyzing the actual value with the theoretical value, and determining a faulty module among the plurality of modules to be detected according to a comparison and analysis result.

13. The server fault locating method according to claim 1, wherein the target performance parameter comprises a bandwidth, and the step of acquiring an actual value of the target performance parameter during operation of each of the modules to be detected comprises:
when a number of batch instructions sent by each of the modules to be detected during an operation is a fixed number, acquiring a running time of the batch instructions to use the running time as an actual value of bandwidth corresponding to this module to be detected.

14. The server fault locating method according to claim 1, wherein the plurality of modules to be detected comprise a motherboard module, a controller module, a backplane module, and a hard disk module, and the motherboard module, the controller module, the backplane module, and the hard disk module are electrically connected in sequence.

15. The server fault locating method according to claim 2, wherein the adjacent modules to be detected are determined based on connection relationships between the plurality of modules to be detected.

16. The server fault locating method according to claim 6, wherein the step of tuning the faulty module according to the fault category comprises:
detecting a setting mode of the server based on the determined fault category to tune the faulty module.

17. The electronic device according to claim 11, wherein the step of determining a theoretical value of each target performance parameter in each of the modules to be detected based on the topology architecture information comprises:
acquiring a bandwidth parameter of each of the modules to be detected in current fault locating, so as to determine a data block corresponding to the bandwidth parameter;
based on the attribute information corresponding to the modules to be detected, determining a rate and a bandwidth of a node between adjacent modules to be detected; and
based on the data block and the rate and bandwidth, determining a bandwidth theoretical value corresponding to each of the modules to be detected.

18. The electronic device according to claim 11, wherein the target performance parameter comprises IOPS, and the step of determining a theoretical value of each target performance parameter in each of the modules to be detected based on the topology architecture information comprises:
acquiring a maximum number of batch instructions and a running time of batch instructions sent by the modules to be detected; and
based on the maximum number of batch instructions and the running time of the batch instructions, determining a theoretical value of IOPS corresponding to each of the modules to be detected.

19. The electronic device according to claim 11, wherein the target performance parameter comprises an instruction running time of each of the modules to be tested, and the step of comparing and analyzing the actual value with the theoretical value, and determining a faulty module among the plurality of modules to be detected according to a comparison and analysis result comprises:
based on a relationship of size between a bandwidth theoretical value and a bandwidth actual value of each of the modules to be detected, determining a first target module where the actual value exceeds the theoretical value among the modules to be detected;
based on a relationship of size between a theoretical value of the instruction running time and an actual value of the instruction running time of each of the modules to be detected, determining a second target module where the actual value exceeds the theoretical value among the modules to be detected; and
determining the faulty module based on the first target module and the second target module.

20. The electronic device according to claim 11, wherein the server fault locating method further comprises:
determining a fault category based on attribute information of the faulty module; and
tuning the faulty module according to the fault category.

21. The non-transient computer-readable storage medium according to claim 12, wherein the step of determining a theoretical value of each target performance parameter in each of the modules to be detected based on the topology architecture information comprises:
acquiring a bandwidth parameter of each of the modules to be detected in current fault locating, so as to determine a data block corresponding to the bandwidth parameter;
based on the attribute information corresponding to the modules to be detected, determining a rate and a bandwidth of a node between adjacent modules to be detected; and
based on the data block and the rate and bandwidth, determining a bandwidth theoretical value corresponding to each of the modules to be detected.

22. The non-transient computer-readable storage medium according to claim 12, wherein the target performance parameter comprises IOPS, and the step of determining a theoretical value of each target performance parameter in each of the modules to be detected based on the topology architecture information comprises:
acquiring a maximum number of batch instructions and a running time of batch instructions sent by the modules to be detected; and
based on the maximum number of batch instructions and the running time of the batch instructions, determining a theoretical value of IOPS corresponding to each of the modules to be detected.

23. The non-transient computer-readable storage medium according to claim 12, wherein the target performance parameter comprises an instruction running time of each of the modules to be tested, and the step of comparing and analyzing the actual value with the theoretical value, and determining a faulty module among the plurality of modules to be detected according to a comparison and analysis result comprises:
based on a relationship of size between a bandwidth theoretical value and a bandwidth actual value of each of the modules to be detected, determining a first target module where the actual value exceeds the theoretical value among the modules to be detected;
based on a relationship of size between a theoretical value of the instruction running time and an actual value of the instruction running time of each of the modules to be detected, determining a second target module where the actual value exceeds the theoretical value among the modules to be detected; and
determining the faulty module based on the first target module and the second target module.
